(19) United States
(12) Patent Application Publication
(10) Pub. No.: US 2009/0202026 A1
(43) Pub. Date: Aug. 13, 2009

(54) METHOD, NETWORK, APPARATUS AND COMPUTER PROGRAM FOR USING QUALIFYING CIRCUITS IN CLOCK AND DATA RECOVERY CIRCUITS

(75) Inventor: Shuo Huang, Novato (CA)

Correspondence Address: FITZPATRICK CELLA HARPER & SCINTO, 30 ROCKEFELLER PLAZA, NEW YORK, NY, 10112, US

(73) Assignee: Tellabs Petaluma, Inc., Naperville, IL (US)

(21) Appl. No.: 12/028,328

(22) Filed: Feb. 8, 2008

(51) Int. Cl. H04L 7/00

(52) U.S. Cl. 375/355

(57) ABSTRACT

A method for performing CDR on a digital transmission, and an apparatus, system, and computer program that operate in accordance with the method. The method includes oversampling the digital transmission into oversampled data, detecting a frequency component of the oversampled data, qualifying a decision logic to select a sample of the oversampled data, and selecting at least one sample of the oversampled data using the decision logic.

### BACKGROUND

1. Field

Example aspects of the present invention generally relate to the transmission of data in a communications network, and more particularly to performing clock and data recovery on a digital transmission.

2. Related Art

In the telecommunications industry, network service providers transmit multimedia information, including voice, video, and data information, to users of their networks via a local loop distribution network, one example of which is a passive optical network (PON). A PON can be classified according to the location where optical-electrical conversion of signals occurs. For instance, one PON classification is a fiber-to-the-node (FTTN) network, in which optical-to-electrical conversion typically occurs at nodes local to a number of subscribers, and the subscriber equipment connects to the nodes using traditional coaxial or twisted-pair electrical wiring. Similarly, in a fiber-to-the-premises (FTTP) network, which is another classification of PON, conversion typically occurs at a subscriber's premises. Other examples of PONs include fiber-to-the-business (FTTB), fiber-to-the-curb (FTTC) and fiber-to-the-home (FTTH) networks. These types of networks are herein referred to generally as “FTTx networks.”

A typical FTTx PON includes one or more optical line terminals (OLTs), which can be located at a service provider's central office and can include one or more PON cards. Various example configurations of a FTTx network are shown in FIG. 1. In a typical FTTP network, each OLT is communicatively coupled to one or more optical network terminals (ONTs), each of which in turn is communicatively coupled to customer premises equipment (CPE) used by end users (e.g., customers, subscribers, and the like) of the network services (e.g., voice services, video services, and/or data services) provided by the service provider. In a typical FTTC network, each OLT is communicatively coupled to optical network units (ONUs) via an optical distribution network (ODN). The ONUs are then communicatively coupled to CPE through network terminals (NTs) such as, for example, digital subscriber line (DSL) modems, asynchronous DSL (ASDL) modems, very high speed DSL (VDSL) modems, and/or the like. In a typical FTTN network, each OLT is communicatively coupled to remote digital terminals (RDTs) or other remote terminals (RTs). CPE are then communicatively coupled to RDTs through NTs. Thus, depending on the specific FTTx configuration, the user node may be an ONT, an optical network unit ONU, and/or a remote digital terminal RDT.

A communication made in a FTTx network can be processed such that the communication is suitable for transmission through the network. Pre-transmission processing of a communication may include, for example, the encoding of one or more clock signals and/or one or more data streams. Therefore, an encoded communication may need to be decoded when received by an element in the FTTx network. Such post-transmission decoding may involve recovery of the clock signal(s) and data stream(s). This procedure is generally referred to as clock and data recovery (CDR).

### SUMMARY

According to an example aspect of the invention, a method is provided; a system, apparatus, and computer program product that operate in accordance with the method also are provided. The method performs clock and data recovery (CDR) on a digital transmission, and includes oversampling the digital transmission into oversampled data, detecting a frequency component of the oversampled data, qualifying a decision logic to select a sample of the oversampled data, and selecting at least one sample of the oversampled data using the decision logic.

Further features and advantages, as well as the structure and operation, of various example embodiments of the present invention are described in detail below with reference to the accompanying drawings.

### BRIEF DESCRIPTION OF THE DRAWINGS

The features and advantages of the example embodiments of the invention presented herein will become more apparent from the detailed description set forth below when taken in conjunction with the drawings. Like reference numbers between two or more drawings indicate identical or functionally similar elements.

FIG. 1 is a network diagram illustrating example configurations of a PON.

FIG. 2 is a time-domain waveform of an example digital transmission.

FIGS. 3A-D are time-domain waveforms of other example digital transmissions.

FIG. 4 shows a flow diagram of a procedure in accordance with an example embodiment of the invention.

FIG. 5 is a circuit diagram of an example clock and data recovery circuit operable in accordance with an example aspect of the invention.

FIG. 6 is a circuit diagram of an example qualifying circuit operable in accordance with an example aspect of the invention.

FIG. 7 is a circuit diagram of another example qualifying circuit operable in accordance with another example aspect of the invention.

FIG. 8 is a diagram illustrating an example operation of a clock and data recovery circuit.

FIG. 9 is a logical diagram of a control module, which may be suitable for practicing one or more example embodiments of the invention.

FIG. 10 shows an example data processing architecture.

### DETAILED DESCRIPTION

The following description and example embodiments are described in the context of a PON having ONTs as user nodes. However, this context has been chosen solely for the sake of simplicity; the invention is not limited for use only with ONTs, but can also be used in conjunction with other user nodes such as, for example, ONUs, RDTs, any other suitable types of nodes operable within a communication network, or any combination thereof. Moreover, upon reading of the following description it will be apparent to one with skill in the relevant arts how to practice alternative example embodiments within communication networks other than PONs.

In a typical PON, downstream digital communications, e.g., communications transmitted from an OLT to one or more ONTs, are transmitted over a single fiber optic channel operating in a continuous mode. Included in the downstream communications is a data stream, which contains timing information generated by the OLT that enables a receiving device, e.g., an ONT, to recover a clock signal, hereinafter referred to as a “downstream clock.” In order for a communication to be properly decoded by an ONT, the ONT first must lock to the downstream clock. Once the clock has been locked, the ONT can then use the clock to determine the proper alignment of bits within the bitstream of the downstream communication. This two-step procedure is generally referred to as clock and data recovery (CDR); CDR is also known as clock phase and data recovery. Devices such as, for example, ONTs typically perform CDR on downstream communications, i.e., continuous mode communications, through the use of phase-locked loop (PLL) circuitry and the like.

Similarly, upstream digital communications, i.e., communications transmitted from one or more ONTs to an OLT, are typically transmitted with timing information generated by the ONT (hereinafter referred to as an “upstream clock”). The ONT generates the upstream clock based on the downstream clock signal, which has been recovered by the ONT through CDR of one or more downstream communications; generally, the upstream clock is at the same frequency as the downstream clock. The OLT then performs its own CDR procedure on the upstream communication. In this manner, the OLT can receive (and perform CDR on) all upstream communications transmitted from the various ONTs in the PON.

In a typical PON, however, upstream communications are transmitted over a fiber optic channel operating in a burst mode; unlike downstream communications, where a single OLT sends communications to multiple ONTs, for upstream communications multiple ONTs must send communications to a single OLT. Because simultaneous upstream transmissions from multiple ONTs can interfere with one another, which can prevent proper data transmission and recovery, each ONT can only send a communication during a brief, individually-allocated time. Thus, upstream transmissions occur in bursts, where each burst can originate from a different ONT. In a GPON, an individual upstream burst is generally referred to as a transmission container (T-CONT), as described in International Telecommunications Union (ITU) publication ITU-T G.984.3. As used herein, “T-CONT” can refer to an upstream burst communication in any PON and/or other suitable communications network.

In order for an individual ONT to transmit a T-CONT at its proper allocated time, the downstream clock, which is sent by the OLT in a downstream transmission and recovered by the ONT during CDR of the downstream transmission together with a bandwidth map embedded in the downstream frames, can be used by the ONT to determine when to transmit its T-CONT. Although each ONT generates its upstream clock based upon the downstream clock signal sent by the OLT, because the ONTs in a typical PON are located at various distances from the OLT, there can be phase differences between the upstream clocks received from the various ONTs in the PON; the physical signals, e.g., optical and/or electrical, in which communications are encoded travel at finite speeds and require varying lengths of time to travel different distances. Thus, to receive and recover data from upstream communications, the OLT must lock on to a different upstream clock for each T-CONT prior to decoding the data encoded in an individual communication received from an ONT.

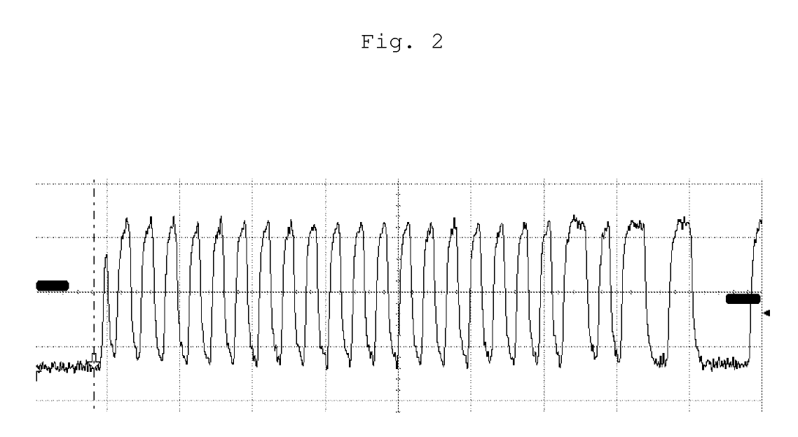

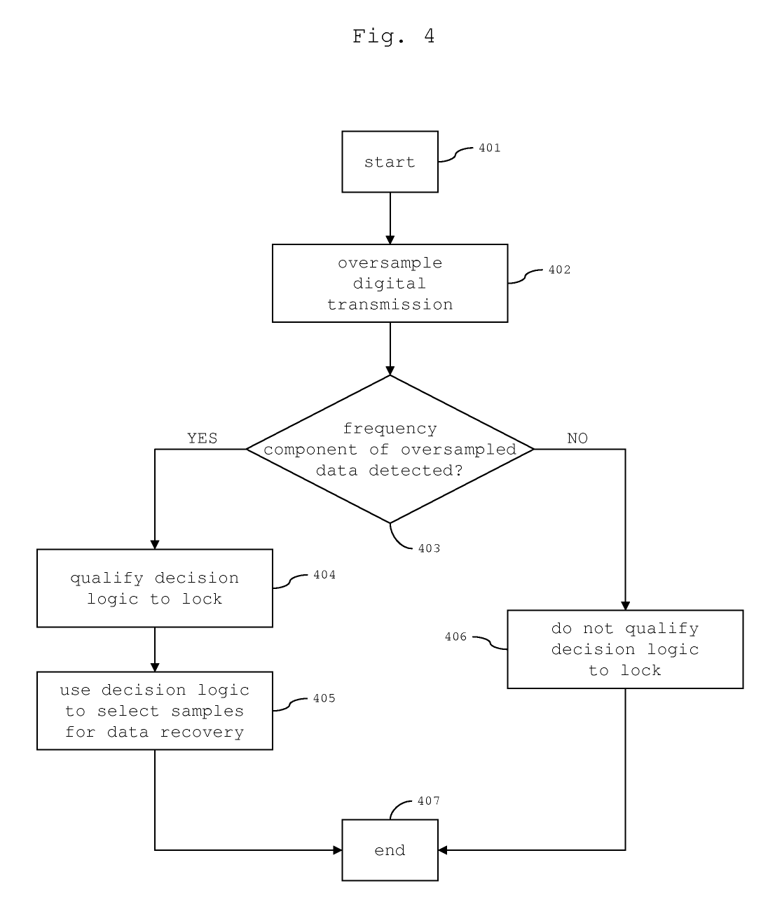

A typical structure of a T-CONT is as follows. Encoded at the start of the transmission is a preamble, an example waveform of which is described below in connection with FIG. 2. A preamble can be a predetermined byte pattern, which can contain timing information (e.g., an upstream clock) and which can be used by, for example, a CDR procedure to lock onto the T-CONT. By properly locking onto a T-CONT, a CDR procedure can then recover a delimiter and encoded data, both of which are described below. Furthermore, as described below in connection with FIGS. 4-8 (and according to an example aspect of the invention), the preamble of a T-CONT can be used by a qualifying circuit to permit an oversampling CDR circuit to correctly lock onto the T-CONT. A preamble can have any predetermined length; according to ITU-T G.984.3, a recommended length for a preamble of a GPON T-CONT is 44 bits. A preamble can also have any predetermined pattern, though the hexadecimal form of a commonly-used preamble byte pattern is 0xAA (or, in binary form, eight bits alternating between “1” and “0”). Other example hexadecimal preamble patterns are 0x55, 0xCC, and the like.

Encoded following the preamble is a delimiter, which can also be a byte pattern. An example use of a delimiter is for the performance of byte alignment, as described below in connection with byte aligner 540. Although ITU-T G.984.3 standardizes a GPON delimiter length to 16 or 20 bits, other delimiter lengths are possible (and can be standardized according to other network standards), including delimiter lengths of, for example, eight bits, 12 bits, and the like. An example 20-bit delimiter is 0xB5983, although other delimiters may be used in the transmission of upstream burst communications.

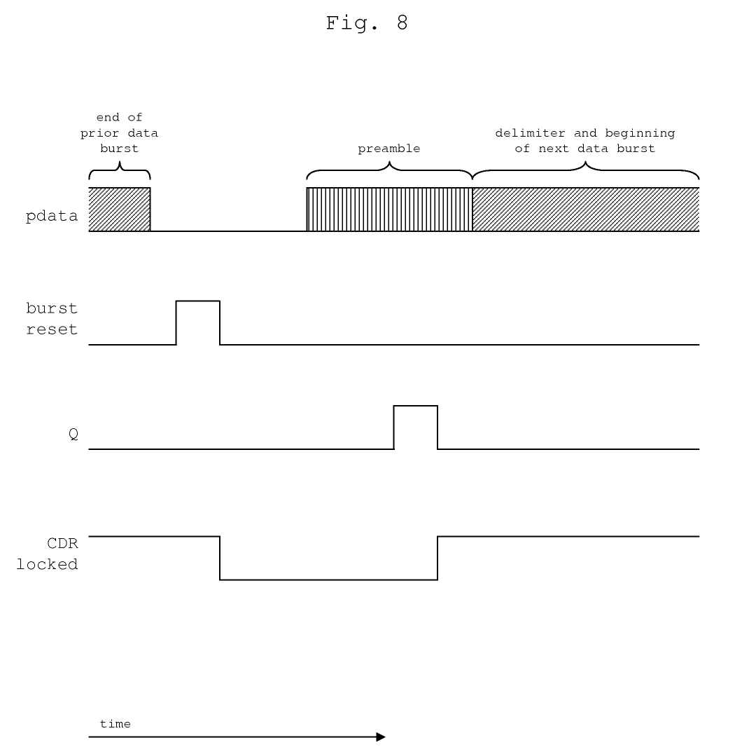

Following the delimiter is encoded data, which can be recovered through, for example, an oversampling CDR procedure. Between consecutive T-CONTs there can a gap during which no encoded information is sent. According to ITU-T G.984.3, a 32-bit gap is recommended between consecutive GPON T-CONTs (though other gap lengths are possible). Thus, by combining a 0xAA preamble pattern with a delimiter as described above, the start of T-CONT (including the preceding silent gap) can be printed in hexadecimal form as 00000000AAAAAAAAAAAB5983. The encoded data of the T-CONT can follow this starting pattern. The structure of an example T-CONT is further described below in connection with FIG. 8.

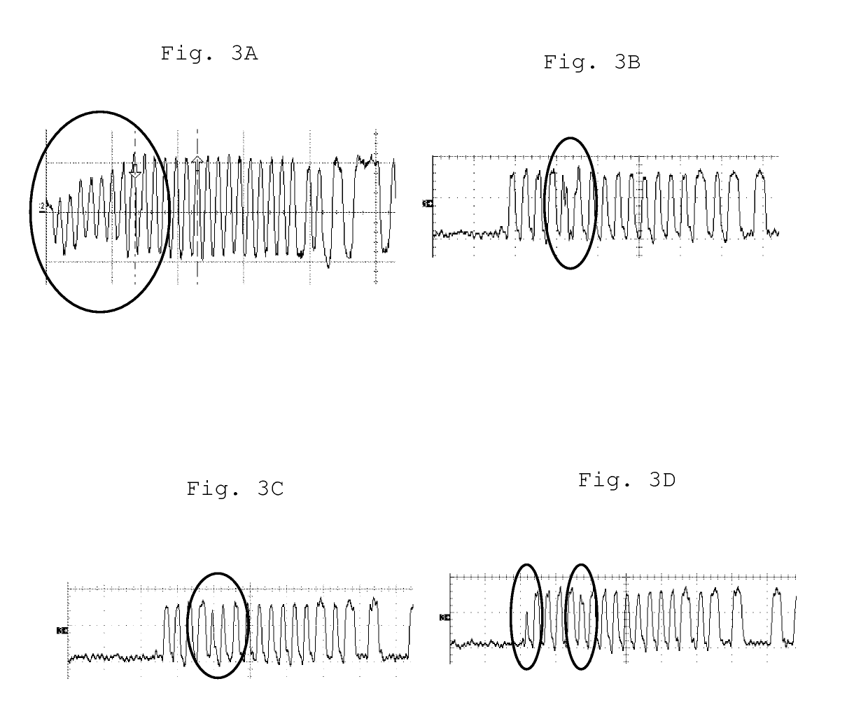

FIG. 2 shows a waveform of an example preamble having a 0xAA byte pattern, which may be an example beginning of a T-CONT. The waveform, which is a voltage function dependent upon time, is an oscilloscope capture of the output from the low-voltage positive emitter-coupled logic (LVPECL) of an optical module. (An optical module is a typical component of a GPON network element such as, for example, an ONT or an OLT; the optical module can be configured to perform the optical-to-electrical conversion of PON communications such as T-CONTs.) In viewing the waveform capture of FIG. 2 from left to right, the capture begins during a period of no signal, which may represent, for example, a signal gap between T-CONTs. The waveform then begins with the preamble bits, which comprise a 0xAA byte pattern and exhibit consistent and equally-spaced pulsewidths. (An exception is the first bit of the preamble, which has a narrower pulsewidth. Such narrower pulsewidth may be caused by, for example, one or more transmission effects described below in connection with FIGS. 3A-D.) As described above, the locking of a CDR procedure typically must be performed during the preamble, such that the delimiter and encoded data can be properly recovered.

Procedures for performing CDR on T-CONTs vary. PLL circuits, which typically are used for continuous downstream transmissions, may have limited effectiveness when used for upstream CDR applications because the time required for a PLL circuit to lock onto to a clock signal can be much longer than length of time occupied by the upstream clock, e.g., the preamble of a T-CONT; thus, PLLs may not be suitable for CDR on upstream communications sent at high data transmission rates. (High data transmission rate T-CONTs may occur in high-speed networks such as, for example, a broadband PON (BPON), an Ethernet PON (EPON), a gigabit PON (GPON), a wavelength division multiplexed PON (WDM-PON), and the like. Upstream data transmission rates in networks such as these may include, for example, 125 Mb/s, 622 Mb/s, 1.25 Gb/s, as well as other data rates.) Therefore, other procedures and/or implementations of CDR can be used to decode T-CONTs transmitted at high data rates. One such procedure is oversampling CDR, as described in U.S. patent application Ser. No. 11/972,775, the disclosure of which is hereby incorporated by reference herein in its entirety, as if fully set forth herein.

Even if a suitable CDR procedure (e.g., oversampling CDR) is performed on a high-speed transmission, however, other transmission effects can complicate the performance of CDR. For example, transmissions that travel long distances over optical fibers can become attenuated, resulting in weak signals received by the OLT. Although weak signals can be amplified by an optical module of an OLT, proper gain adjustments between T-CONTs of varying signal amplitudes can be difficult for the optical module to perform. Such a circumstance may occur when a weak-signal T-CONT (e.g., from an ONT located far from an OLT) is received following a strong-signal T-CONT (e.g., from an ONT located close to the OLT), or vice versa. Furthermore, because the optical module adjusts its gain during the preamble of a T-CONT, until a proper gain level is achieved, there can be no electrical output from the optical module even when portions of the preamble are received. Thus, the optical module can “blind” a CDR circuit to numerous bits of the preamble, which effectively shortens the length of the preamble and can make it difficult for the CDR circuit to properly lock to the T-CONT.

Another transmission effect that can complicate the performance of CDR of a T-CONT is variability in the length of the signal gap between consecutive T-CONTs. Because of the varying distances over which signals physically travel within a network such as, for example, a PON, the signal gap between consecutive T-CONTs can vary from a recommended or standardized length expected by the OLT (e.g., the 32-bit gap recommended by ITU-T G.984.3, as described above). Thus, a preamble for a T-CONT can begin earlier or later than an OLT expects. If such a drift occurs in the signal gap, i.e., the gap is variable, this can lessen the number of preamble bits available for a CDR procedure.

Yet another transmission effect that can complicate CDR is undesirable signal variations in the output of the optical module. These variations can include undesired changes in phase, amplitude, frequency, and the like in the output of the module, and can be introduced by the inherent operation of a given module. As shown below in connection with FIGS. 3A-3D, variations in an optical module output can disrupt or distort a preamble of a T-CONT, causing the CDR procedure to improperly lock into the preamble, and resulting in high bit error rates (BERs) during the recovery of the delimiter and encoded data. The improper locking of a CDR procedure to a T-CONT is referred to herein as “false lock.”

FIGS. 3A-D shows waveforms of example upstream burst transmissions that exhibit one or more of the various transmission effects described above. Like the waveform of FIG. 2, waveforms shown in FIGS. 3A-D are oscilloscope captures of the output from the LVPECL of an optical module. FIG. 3A shows a preamble distorted due to gain adjustment. Highlighted by the encircled area, the period of gain adjustment lasts for several bits. During this period, the bit amplitude varies widely. FIG. 3B shows a preamble exhibiting amplitude and pulsewidth distortions caused by variations in the optical module output. The encircled area, which highlights the ninth and tenth edges (i.e., transitions from “1” to “0” and vice versa), shows strong amplitude variations during periods where the preamble is expected to be steady, i.e., the signal should be either high (“1”) or low (“0”) and not at an intermediate level. FIG. 3C shows a preamble exhibiting amplitude and pulsewidth distortions caused by variations in the optical module output. These frequency distortions result in abnormal pulsewidths, which, as highlighted by the encircled area, occur near the ninth and tenth edges. FIG. 3D also shows a preamble exhibiting amplitude and pulsewidth distortions; in this figure, the distortions occur at both the beginning and the middle of the preamble.

As a whole, the transmission effects described above (and shown by example in FIGS. 3A-3D) can further complicate the performance of CDR on an upstream digital transmission, e.g., a T-CONT transmitted in a PON. Because the transmission effects can cause distortions in the transmission and reduce the effective length of a preamble, it can be difficult for a CDR circuit to properly lock onto the T-CONT. In fact, the cumulative result of these transmission effects can be a reduction in the effective length of the preamble to three or less bytes, i.e., the preamble can become so distorted that CDR locking must occur during the final three or less bytes of the preamble. Thus, CDR procedures such as, for example, oversampling CDR can be prone to false locking onto T-CONTs, increasing the BER and decreasing the overall performance of CDR in the network.

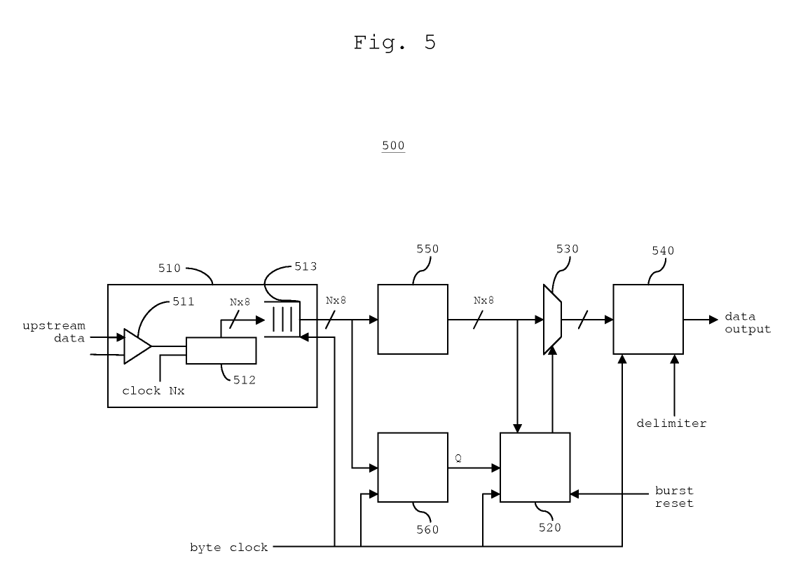

FIG. 4 shows a flow diagram of a procedure of performing CDR on a digital data transmission, according to an example embodiment of the invention. The procedure illustrated by FIG. 4 can be used for performing CDR for applications where false locking can occur such as, for example, data recovery from an upstream data transmission in a PON. At block 401, the procedure is commenced. At block 402, the bitstream comprising the data transmission is oversampled, i.e., one or more samples are taken of each incoming bit. The oversampled bitstream is hereinafter referred to as “oversampled data.” The oversampled data can be any length, although according to an example aspect of the invention, one incoming byte (eight incoming bits) is oversampled every clock cycle, for a total of 40 oversampled bits per clock cycle. Oversampling can be performed by, for example, oversampler 511 (described below in connection with FIG. 5) or any other suitable sampler. The data transmission rate (or “bit rate”) multiplied by the number of samples made per incoming bit is the oversampling ratio, which is referred to herein as “N.” Each consecutive N samples made per incoming bit is referred to herein as a “sample set.”

Those having skill in the relevant arts will recognize that the oversampling occurring at block 402 may not be aligned to the bit frequency of the incoming bitstream. However, though the OLT (or other receiving device) may not know the bit alignment, the OLT can correctly determine the data transmission rate because, as described above, when communicating upstream in a PON, an ONT uses a recovered downstream clock to transmit its upstream data. Thus, an OLT can use its own local clock to determine the bit rate and oversample the incoming transmission accordingly. As a result, the OLT can ensure that, on average, N samples are made per incoming bit.

In an example embodiment of the invention, the transmission oversampled at block 402 is a preamble of a T-CONT. As described above, a preamble transmitted by an ONT in a PON can be subject to variations in an optical module output and/or other transmission effects, as shown in FIGS. 3A-D. Therefore, in this embodiment, the incoming preamble may be distorted, and each of the N samples made per upstream input bit may not have the same value. For example, a transmitted bit of “1” may vary in amplitude during the bit period, resulting in samples of both “1” and “0.” As another example, incoming bits may have abnormal pulsewidths, resulting one transmitted bit period lasting for N−1 samples and the following transmitted bit period lasting for N+1 samples. As a result, if the incoming preamble is distorted, it may cause a CDR to lock to a bit alignment based on distorted edges, i.e., transitions between “1” and “0.” This false lock makes the bit alignment poor for the later data bits and results in a higher bit error rate. However, as described below in connection with blocks 403 and 404, frequency component detection of the oversampled data can be used to qualify a CDR procedure to lock onto the T-CONT, which may in turn prevent the occurrence of false locking.

Following the oversampling of the incoming data transmission at block 402, a decision block can be entered at block 403. At this block it is determined whether or not a frequency component of the oversampled data is detected. As described above in connection with FIG. 2, at least a portion of an upstream data transmission, e.g., a T-CONT, can be comprised of a preamble. Furthermore, the preamble can be any predetermined byte pattern such as, for example, 0xAA, 0x55, 0xCC and the like. Thus, such a byte pattern can have an associated frequency component, which can be proportional to the bit rate. For example, 0xAA is a byte pattern having bits that alternate between “1” and “0.” As a result, the preamble assembled from such a pattern repeats every two bits; the frequency component of the preamble is one-half of the bit rate. Similarly, 0xCC is a byte pattern having bits repeating the bit pattern “100,” and its associated frequency component is one-fourth of the bit rate. The example operation of a device detecting a frequency component of oversampled data is described below in connection with qualifier 560 and qualifying circuits 600 and 700.

The detection of a frequency component at block 403 need not involve a calculation or other determination of a magnitude of a frequency (e.g., 1 GHz). Rather, a frequency component can be detected by a comparison of the bits comprising the oversampled data. One example of such a comparison is the calculation of one or more pattern detection equations, as discussed below.

The detection of a frequency component at block 403 can indicate that, as oversampled, a received preamble has a well-defined byte pattern that is not overly distorted by any of the various transmission effects described above, i.e., at least some of the oversampled data exhibits periodicity. CDR locking onto oversampled data such as this generally will not result in false lock. Thus, oversampled data for which a frequency component is detected (i.e., having periodicity) can be suitable for CDR locking. For example, the detection of the one-half bit rate frequency corresponding to a 0xAA preamble can indicate that the pattern of alternating “1” and “0” bits has been received by an OLT. Thus the preamble is well-defined, i.e., not distorted by variations in an optical module output and/or other transmission effects. A well-defined preamble (e.g., the preamble shown in FIG. 2) can be suitable for locking by an oversampling CDR procedure. If a frequency component is detected at block 403, a decision “YES” can be entered and the procedure progresses to block 404.

On the other hand, if a frequency component is not detected at block 403, the absence of detection can indicate that the preamble being received is not well-defined. Such a preamble may be affected by transmission effects such as, for example, distortions at the start of and during the preamble, examples of which are described above in connection with (and shown by) FIGS. 3A-D. Furthermore, such a preamble may not be suitable for locking by a CDR procedure. In this instance, if locking is performed, the CDR may false lock to the distorted portion of the preamble, resulting in increased bit errors when recovery of the transmission (e.g., a delimiter and encoded data) is performed. Thus, if a frequency component is not detected at block 403, a decision “NO” can be entered and the procedure progresses to block 406.

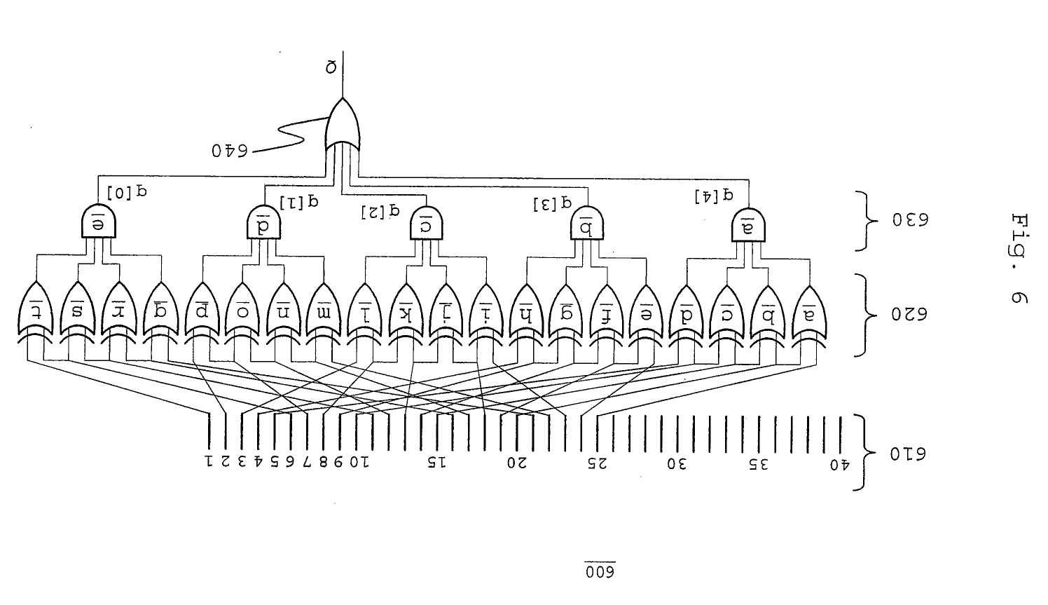

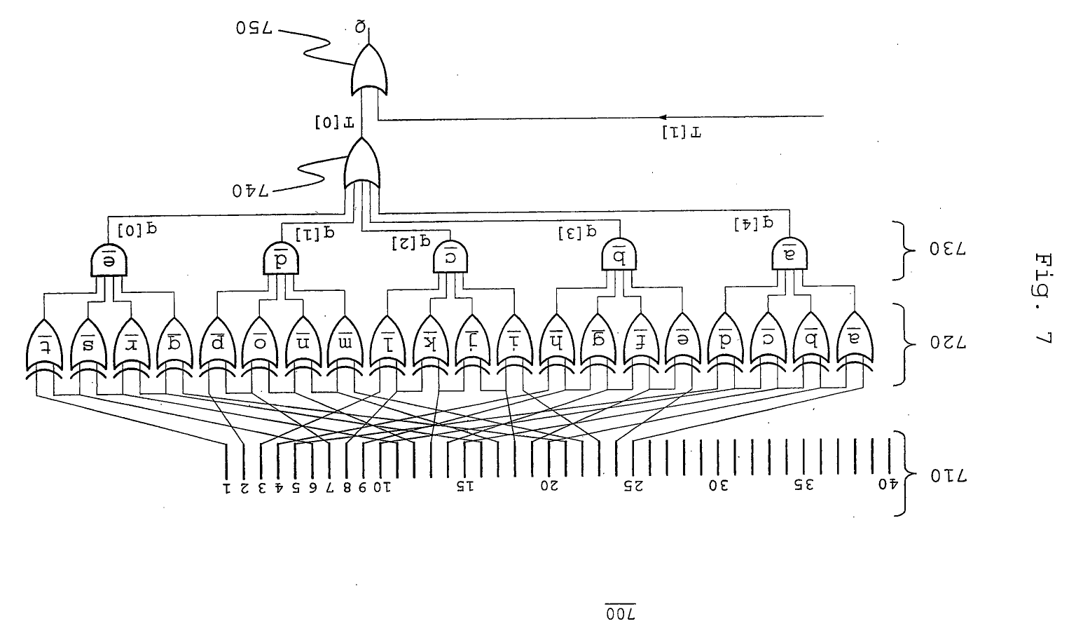

In an example embodiment of the invention, a frequency component can be detected at block 403 by a qualifying circuit such as, for example, qualifying circuits 600 and 700. As described below and also in connection with FIGS. 6 and 7, a qualifying circuit can be configured to use combinational logic to compare samples from the oversampled data in order to detect a frequency component.

In an example embodiment of the invention, a frequency component in the oversampled data can be detected via a calculation of one or more pattern detection equations. A pattern detection equation can determine if there is a pattern, i.e., a frequency component associated with a byte or bit pattern, in oversampled data; pattern detection can be performed by the use of, for example, combinatorial logic. A pattern detection equation (s) can be constructed to detect a frequency component over a predetermined bit width, which is hereinafter referred to as “W.” The value of W corresponds to the number of sets of adjacent upstream bits over which frequency component detection occurs. Thus, if W=1, then pattern detection is limited to one set of adjacent bits (2 bits total). Similarly, if W=2, then a pattern detection occurs over to two sets of adjacent bits (3 bits total, i.e., a detection between the first and second bit and a detection between the second and third bit), and so forth. The value of W can be selected by, for example, CDR decision logic (e.g., decision logic of sampling point decider 520). If selected by in this manner, W can be proportional to the number of sampled bits used by a CDR procedure to lock onto oversampled data.

A description of an example pattern detection equation is as follows. Consider an incoming upstream transmission of a byte pattern (e.g., a preamble of a T-CONT), which can be oversampled at block 403. If, for example, N=5, then there are, on average, five oversampled bits per incoming bit. Thus, if the preamble is 0xAA, then an example set of incoming bits can be “1010” and the corresponding oversampled data can be “11111000001111100000” (if there are no transmission effects, variations in an optical module output, etc.). To detect the alternating pattern, the pattern detection equation can compare the values of bits from different sample sets. For example, an individual pattern detection can be obtained by comparing each n-th (e.g., first, second, third) bit from a first sample set to a corresponding n-th bit from a second sample set. If the values of the bits differ, then the pattern is detected between the two bits. By combining the results of many individual pattern detections in a logical fashion, pattern detection equations can determine whether there is a frequency component to the oversampled bitstream.

For further description of pattern detection equations, consider a specific example where N=5 and W=4. Because N=5, there can be five sampled bits per sample set (and five sampled bits per incoming data bit). Furthermore, because W=4 there are four sets of bits (i.e., five incoming bits) compared. In this example, the following set of equations can detect patterns in the oversampled data:

$$\begin{matrix}q [ 0 ] = ( pdata [ 0 ] ⊕ pdata [ 5 ] ) ⋂ ( pdata [ 5 ] ⊕ pdata [ 10 ] ) ⋂ ( pdata [ 10 ] ⊕ pdata [ 15 ] ) ⋂ ( pdata [ 15 ] ⊕ pdata [ 20 ] ) ; & ( 1 ) \\ q [ 1 ] = ( pdata [ 1 ] ⊕ pdata [ 6 ] ) ⋂ ( pdata [ 6 ] ⊕ pdata [ 11 ] ) ⋂ ( pdata [ 11 ] ⊕ pdata [ 16 ] ) ⋂ ( pdata [ 16 ] ⊕ pdata [ 21 ] ) ; & ( 2 ) \\ q [ 2 ] = ( pdata [ 2 ] ⊕ pdata [ 7 ] ) ⋂ ( pdata [ 7 ] ⊕ pdata [ 12 ] ) ⋂ ( pdata [ 12 ] ⊕ pdata [ 17 ] ) ⋂ ( pdata [ 17 ] ⊕ pdata [ 22 ] ) ; & ( 3 ) \\ q [ 3 ] = ( pdata [ 3 ] ⊕ pdata [ 8 ] ) ⋂ ( pdata [ 8 ] ⊕ pdata [ 13 ] ) ⋂ ( pdata [ 13 ] ⊕ pdata [ 18 ] ) ⋂ ( pdata [ 18 ] ⊕ pdata [ 23 ] ) ; \\ and & ( 4 ) \\ q [ 4 ] = ( pdata [ 4 ] ⊕ pdata [ 9 ] ) ⋂ ( pdata [ 9 ] ⊕ pdata [ 14 ] ) ⋂ ( pdata [ 14 ] ⊕ pdata [ 19 ] ) ⋂ ( pdata [ 19 ] ⊕ pdata [ 24 ] ) . & ( 5 )\end{matrix}$$

In equations (1)-(5), the symbol ⊕ represents the Boolean logic operator XOR and symbol ∩ represents the Boolean logic operator AND. Each pdata[i] is an individual sample of the oversampled data. (For N=5, the complete set of oversampled data for one incoming byte is pdata[39:0], where pdata[39] is the first sample of the most significant bit (MSB); because the predetermined bit width w is less than the bit width of the incoming data, equations (1)-(5) only perform frequency component detection on part of the oversampled data.) Therefore, each q[i] represents a single frequency component detection over the bit width. Because there are five samples per incoming bit, there can be five corresponding frequency component detections.

The results of equations (1)-(5) can be combined to determine whether there are any frequency component detections between each of the N sample sets over for the predetermined bit length W. An equation which can combine the results of equations (1)-(5) is:

$$Q = {{⋃}_{i = 0}}^{4} q [ i ] , \qquad ( 6 )$$

where the symbol ∪ represents a summation of the Boolean logic operator “OR.” The result of equation (6) is Q, which can be an example of a qualifying signal, as described below; Q can be used to qualify a CDR procedure to lock onto oversampled data. The value of Q in equation (6) equals “1” when at least one of the results of equations (1)-(5) equals “1.” Conversely, if all of q[i] equal “0,” then Q=0. As described below, qualifying circuits 600 and 700 (described in connection with FIGS. 6 and 7, respectively) are example frequency-detecting components that can be configured to perform pattern detection equations such as, for example equations (1)-(6).

The result of equations (1)-(6) can be further illustrated by considering these equations in the example circumstances of ideal (e.g., no distortions, no transmission effects, no variations in an optical module output, etc.) and non-ideal transmissions of a 0xAA preamble received at, for example, an OLT. In this example, each XOR operation performed in equations (1)-(5) will yield “1” (indicating a change between “1” and “0”—or vice versa—in the preamble bits), and each q[i] will also equal “1,” resulting in Q having a value of “1.” However, if the transmission is non-ideal and there are distortions in the 0xAA preamble, each of the five oversampled bits of a single preamble bit may not have the same value. Thus, in this circumstance, some of the XOR operations can yield “0” and, as a result, one or more of equations (1)-(5) also can yield “0.” Even though some of the q[i] may have a value of “0,” if at least one q[i] is “1,” then a frequency component is detected, and Q is “1,” However, if all of equations (1)-(5) yield “0,” which may occur when the preamble is particularly distorted, then no frequency component is detected and Q can equal “0.” If Q equals “0,” then no frequency component is detected at block 403, and a decision “NO” can be entered.

Those having skill in the relevant arts will recognize that a general form of pattern detection equations (of which equations (1)-(6) represent the specific form where N=5 and W=4) can be written as follows:

$$q [ i ] = {{⋂}_{j = 0}}^{W - 1} ( pdata [ i + j \cdot N ] ⊕ pdata [ i + ( j + 1 ) \cdot N ] ) , \qquad ( 7 )$$

where i ranges from zero to (N−1) and the symbol ∩ represents a summation of the Boolean logic symbol “AND.” Thus, a general form of Q (equation (6) being a specific example thereof) can be written as:

$$Q = {{⋃}_{i = 0}}^{N - 1} q [ i ] . \qquad ( 8 )$$

Furthermore, where w<8, the number of sampled bits for which frequency component detection is performed is less than the total number of incoming bits (e.g., in the circumstance of the oversampling of one incoming byte per clock cycle, eight incoming bits). Therefore, in an example embodiment of the invention, frequency component detection at block 403 can be performed by multiple frequency detecting components such as, for example, multiple circuits, of which circuit 600 (described below in connection with FIG. 6) is one example. The multiple components together can perform frequency component detection on an entire set of oversampled data (e.g., 40 oversampled bits of eight input bits). In this example embodiment, the complete set of logical equations performed by the multiple components can be given by the following equation:

$${q}^{′} [ i ] = {{⋃}_{k = 0}}^{M < \frac{8}{W}} \{ {{⋂}_{j = k \cdot W}}^{( k + 1 ) \cdot W - 1} pdata [ i + j \cdot N ] ⊕ pdata [ i + ( j + 1 ) \cdot N ] \} , \qquad ( 9 )$$

where i ranges from 0 to N−1 and k is another index variable. Thus, as shown in equation (9), for each q′[i], if any of the multiple components detects a frequency component, the value of q′[i] can equal “1.” In this example embodiment, the results of all q′[i] given by equation (9) can be combined according to the following equation:

$$Q = {{⋃}_{i = 0}}^{N - 1} {q}^{′} [ i ] . \qquad ( 10 )$$

Q may be further expanded and rearranged as follows:

$$\begin{matrix}Q = {{⋃}_{i = 0}}^{N - 1} {{⋃}_{k = 0}}^{M < \frac{8}{W}} \\ \{ {{⋂}_{j = k \cdot w}}^{( k + 1 ) \cdot W - 1} ( pdata [ i + j \cdot N ] ⊕ pdata [ i + ( j + 1 ) \cdot N ] ) \} \\ = {{⋃}_{k = 0}}^{M < \frac{8}{W}} {{⋃}_{i = 0}}^{N - 1} \\ \{ {{⋂}_{j = k \cdot W}}^{( k + 1 ) \cdot W - 1} ( pdata [ i + j \cdot N ] ⊕ pdata [ i + ( j + 1 ) \cdot N ] ) \} \\ = {{⋃}_{k = 0}}^{M < \frac{8}{W}} T [ k ] .\end{matrix} \qquad ( 11 )$$

In equation (11), T[k] is given by the following:

$$T [ k ] = {{⋃}_{i = 0}}^{N - 1} \{ {{⋂}_{j = k \cdot W}}^{( k + 1 ) \cdot W - 1} pdata [ i + j \cdot N ] ⊕ pdata [ i + ( j + 1 ) \cdot N ] \} , \qquad ( 12 )$$

where k ranges from 0 to M, and M is the largest integer less than 8/W. Thus, T[k] can represent an output from one of the multiple components performing the frequency component detection, as discussed below in connection with FIG. 7.

At block 404, which can be entered into following a decision “YES” at block 403, a decision logic is qualified to lock onto the digital transmission. As described above and in U.S. patent application Ser. No. 11/972,775, a decision logic can be used in an oversampling CDR procedure to select oversampled bits for output as recovered data. As used herein with respect to a decision logic, the term “qualifying” should be understood as enabling, activating, turning on, or otherwise permitting operation of the decision logic to lock onto to a digital transmission when a frequency component in the transmission is detected. Thus, until the decision logic associated with a CDR procedure is qualified at block 404, the decision logic can be prevented from locking on to the digital transmission.

A decision logic can be qualified at block 404 by, for example, qualifier 560 or qualifying circuits 600 and 700, which are described below, or it may be qualified by any other suitable circuit, device, component, or network element. In an example embodiment of the invention, the decision logic is qualified at block 403 by enabling the decision logic with a signal output from a qualifying circuit, as described below in connection with FIGS. 7 and 8.

At block 405, a decision logic, which can be qualified to lock to oversampled data, operates to select samples from the oversampled data for output as recovered data. An example operation of the selection by the decision logic can be found in U.S. patent application Ser. No. 11/972,775. The selection operation performed by the decision logic is not limited to this example, however, and other selection operations may be performed at block 405. At block 407, the procedure terminates.

Alternatively, at block 406, which can be entered in response to a “NO” decision at block 403, a decision logic is not qualified to lock onto the digital transmission. In this block, the decision logic is not qualified to lock onto oversampled data because a frequency component has not been detected in the data at block 403. As discussed above, an example circumstance in which a frequency component may not be detected in oversampled data is when incoming data is a distorted preamble, a signal gap, and/or non-preamble bits (e.g., delimiter bits and encoded data bits). In this circumstance, the incoming data, once oversampled, may not be comprised of a pattern (e.g., a preamble or other byte pattern) having a detectable frequency component. Because no frequency component is detected, the oversampled data may not be suitable for locking by a decision logic; a locking procedure may result in the false locking of the CDR. As a result, the decision logic is not qualified to lock to the oversampled data.

Performance of block 406 need not involve a physical signal or any other change in the components performing any of the blocks of FIG. 4. For example, a decision logic not qualified to lock prior to the entry of block 406 may not require any input to remain in a non-locking state. At block 407, the procedure terminates.

The flow diagram shown in FIG. 4 is presented for illustrative purposes only; those having skill in the relevant arts will recognize that other configurations are possible and/or not shown. For example, if a frequency component is not detected (“NO” is entered at block 403) and the decision logic is not qualified at block 406, the procedure may be configured to re-enter block 402, in which more of the digital transmission (e.g., another incoming byte) is oversampled for frequency component detection. As another example, even if a decision logic is qualified at block 404 (and selects samples at block 405), the procedure may be configured to re-enter block 402, thereby causing the procedure to continually (e.g., every clock cycle) detect a frequency component prior to the recovery of data.

FIG. 5 shows a circuit diagram of an example CDR circuit 500 in accordance with an example aspect of the invention. CDR circuit 500 can be used for performing CDR on upstream burst mode communications such as, for example, a T-CONT, and its operation can be performed by (and/or included in), for example, an OLT or other network element receiving such communications. Upstream data received by an OLT can be passed to the CDR circuit 500, which is comprised of deserializer 510, sampling point decider 520, demultiplexer 530, byte aligner 540, delay register 550, and qualifier 560.

Deserializer 510 is comprised of oversampler 511, shift register 512, and buffer 513. Oversampler 511 oversamples an upstream data transmission (e.g., a T-CONT) at a sampling rate equal to N multiplied by bit rate (as described above in connection with FIG. 4). Shift register 512 converts the oversampled data from a serial format to a parallel format. Parallel data output from shift register 512 has a bit width of, for example, N multiplied by 8 (“Nx8”). Inputs to shift register 512 can include a serial data input, into which serial data such as, for example, oversampled upstream data can be input, and a clock input. The signal input to the clock input of shift register 512 (designated in FIG. 5 as “clock Nx”) can be, for example, a clock having a frequency equal to the oversampling frequency of oversampler 511, i.e., N multiplied by the bit rate. Other clock signals can be input into shift register 512, including a half-rate clock (which can be used in conjunction with, for example, dual-edge sampling), multiple lower frequency phase-delayed clocks, and the like. Buffer 513 stores parallel format data received from shift register 512 and outputs the data (e.g., a set of N sampled bytes in a parallel Nx8 format) according a control signal received at its clock input. The control signal input to the clock input of buffer 513 (designated in FIG. 5 as “byte clock”) can be a clock having a frequency equal to, for example, the byte rate (⅛ of the bit rate) or any other suitable frequency. For example, if the bit rate is 1.244 Gb/s, the frequency of the byte clock can be 155.52 MHz. The byte clock can be obtained by manipulation and/or routing of a downstream clock, an ONT transmit clock, or any other clock associated with a network such as, for example, a PON.

The following is an example of the manner in which deserializer circuit 510 operates. Consider a T-CONT transmitted over a GPON at a bit rate of 1.25 GB/s. If, for example, oversampler 511 is configured to oversample incoming data at a rate five times greater than the bit rate, then N=5 and the oversampling frequency of oversampler 511 is 6.25 GB/s. Given an input of one byte of the T-CONT, the output of oversampler 511 is a serial data stream of five bytes (40 bits) where the last five bits of the 40-bit bitstream are samples 1-5 of the input byte, the preceding five bits of the bitstream are samples 6-10 of the input byte, and so forth. This serial bitstream is input to shift register 512, which, in the example of N=5, is a 5×8 shift register. Shift register 512 converts the serial bitstream to a parallel bitstream of five sampled bytes, such that samples 1-5 of the upstream data are the least significant bits (or “LSB”) of the five sampled bytes, samples 6-10 are the second LSB of the sampled bytes, and so forth. These five sampled bytes are inputted to buffer 513, which operates according to the above-described byte clock, and then can be further processed and/or manipulated by other elements or modules, such as, for example, sampling point decider 520 and/or qualifier 560.

Although the preceding example has been described in the context of a deserializer having N=5, this example was chosen only to illustrate an operative principle of deserializer 310. The example should not be construed as a limitation on any other example embodiment of the invention, which can have different values for the pertinent parameters and variables.

CDR circuit 500 can further operate as follows. Oversampled data (in parallel format) can be output from deserializer 510 to delay register 550 and qualifier 560. Qualifier 560, of which circuits 600 and 700 (described below) are examples, examines the oversampled data for a frequency component. If a frequency component is detected, qualifier 560 qualifies sampling point decider 520 through an output signal “Q.” Delay register 550 stores oversampled data during the operation of qualifier 560 and outputs the stored data to sampling point decider 520 after each operation of qualifier 560. In this manner, sampling point decider 520 can operate on oversampled data corresponding to the same data operated on by qualifier 560.

Sampling point decider 520 selects certain samples (e.g., one byte) from the multiple samples (e.g., N sampled bytes) oversampled by deserializer 510 for output as recovered data. Sampling point decider 520 can select bits (or bytes) by way of a decision logic (such as a decision logic locked on to a T-CONT). According to an example aspect of the invention, sampling point decider 520 selects samples only when it is locked to the oversampled data, and furthermore only locks when it is qualified to do so. In this manner, it is prevented from selecting samples while false locked to oversampled data, which can increase the BER of CDR circuit 500.

Sampling point decider 520 has a burst reset input which, as described below, can reset a CDR locking of the decider. Signal can be passed to the burst reset by, for example, a bandwidth mapping component (e.g., a BW-MAP circuit, which is not shown in FIG. 5), which can manage upstream (and/or downstream) GPON structures. In this manner, sampling point decider, having been qualified to perform CDR, can be reset after an upstream data transmission (e.g., a T-CONT) in anticipation of (or as a result of) the reception of another upstream transmission.

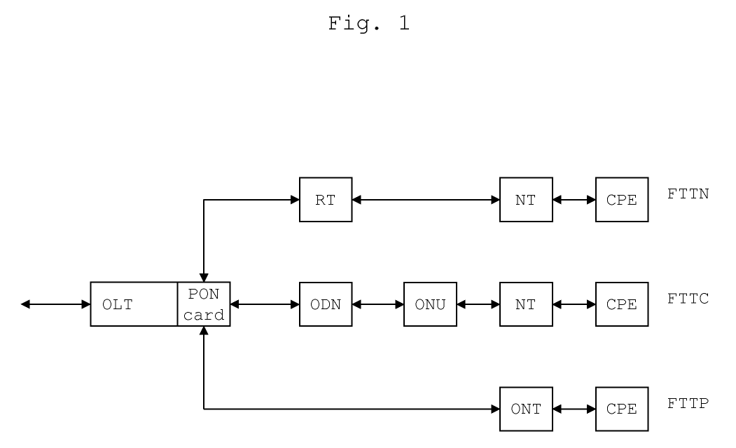

Demultiplexer 530 filters from the oversampled bits only the certain samples selected (e.g., a selected byte) by sampling point decider 520. Byte aligner 540 receives the selected byte from demultiplexer 530 and outputs the byte as recovered data. Byte aligner 540 has a delimiter input, through which a delimiter byte pattern (e.g., 0xB5983 or any 16- or 20-bit byte pattern according to ITU standards) can be passed. The byte pattern can be received from any suitable source such as, for example, a component, device, and/or circuit within an OLT or an ONT, or a source local to or comprising any of the elements of FIG. 1. Byte aligner 540 can use signals passing through the delimiter input to perform a shift, in which the boundary of bytes of recovered data can be aligned to the byte boundary at the transmitting device. The timing of operations performed by sampling point decider 520, demultiplexer 530, byte aligner 540, delay register 550, and qualifier 560 can be controlled by a clock such as the byte clock described above; thus, the various elements of CDR circuit 500 can act in synchronicity.

FIG. 6 is an example circuit diagram of a qualifying circuit 600. Qualifying circuit 600 may be an example of qualifier 560, and may be suitable for practicing one or more example embodiments of the invention. Consistent with above-described equations (1)-(6) and the example operation of deserializer 510—and for the sake of simplicity—qualifying circuit 600 is a specific illustration of a general qualifying circuit; in particular, circuit 600 illustrates a possible configuration when upstream data is oversampled at five times the data transmission rate, i.e., N=5, and a frequency component in oversampled data is detected over a bit width of four, i.e., W=4. Upon review of the following description of circuit 600, those having skill in the art will be able to construct qualifying circuits for values of N other than five and values of W other than four, and also will understand that other circuit combinations and configurations are possible.

Circuit 600 is comprised of input ports 610, XOR gates 620, AND gates 630, and OR gate 640. A byte frequency clock (not shown) can be input into input ports 610. The byte frequency clock can be used to control the timing, incrementing, shifting, and/or other manipulating of data and/or signals in circuit 600.

An example operation of qualifying circuit 600, in which the circuit can detect a frequency component, is as follows. Because N=5, input ports 610 can accept a 5×8 parallel input, such as the five parallel sampled bytes output from deserializer 510. (These five parallel sampled bytes correspond to 40 samples of a byte of upstream data sampled by oversampler 511.) Input ports 610 can be numbered in such a manner that the most significant bit (MSB) of the first byte is at port 39, the MSB of the second byte is at port 38, and so forth; the least significant bit (LSB) of the fifth byte is at port 0. The 40 sampled bits can then be represented by the set pdata[39:0], where the index numbers of the “pdata” variable indicate the ports of the upper and lower bounds of the bit range encompassed by the set.

In accordance with an example aspect of the invention, the sampled bits can be samples of a byte pattern (e.g., a preamble). For example, consider sampled bits of preamble 0xAA. In this example, the incoming data bits alternate between “1” and “0.” If N=5, then, upon oversampling of the incoming data, the 40 sampled bits ideally can alternate between “1” and “0,” with one alternation per five sampled bits. However, as described above, variations in an optical module output and/or other transmission effects can cause distortions to the incoming preamble, resulting in sampled bits that do not have such ideal values. If the sampled bits do not have the ideal values, there may be no pattern detectable by pattern detection equations, resulting in no detection of a frequency component. Thus, the detection of a frequency component in pdata[39:0] can indicate that at least some of the sampled bits alternate according to the ideal manner, in which case the qualifying circuit can qualify a decision logic to lock onto the oversampled data.

Elements 620, 630, and 640 of circuit 600 can be configured to perform the frequency-detecting operations described above in connection with equations (1)-(6). The inputs to each of the XOR gates are two bits of pdata[39:0] from two of the input ports 610. As shown in FIG. 6 and consistent with equations (1)-(6), all of the input ports 610 need not be used in this example operation of circuit 600; however, in other configurations of the circuit (such as that described below in connection with FIG. 7) more or all of input ports 610 can be used. Each of the XOR gates 620 compares the values at its inputs by performing one of the individual XOR operations in equations (1)-(5). For example, XOR gate 620t performs the first XOR operation of equation (1); XOR gate 620s performs the first XOR operation of equation (2), and so forth. As described above in connection with FIG. 4, the output of each of the XOR gates 620 will be “1” if the values of two samples of adjacent preamble bits differ, and will be “0” if the sample values are the same. The outputs of each of the XOR gates 620 are passed to one of the AND gates 630.

AND gates 630 perform the AND operations described in equations (1)-(5). For example, AND gate 630e performs the AND operations of equations (1); AND gate 630d performs the AND operations of equations (2), and so forth. Thus, the output of each of AND gates 630 corresponds to one q[i], i.e., the outputs of the five AND gates 630 correspond to q[1]-q[5]. The outputs of each of the AND gates 630 are passed to OR gate 640.

OR gate 640 performs the operation of equation (6). Therefore, the output of OR gate is “Q.” which can be a qualifying signal. The output of OR gate 640 can be passed to another frequency detecting component (as described below in connection with FIG. 7), or it can be input into another device or circuit element such as, for example, a decision logic associated with sampling point decider 520, in which case “Q” can be used to qualify the decision logic to lock onto oversampled data.

FIG. 7 is another example circuit diagram of a qualifying circuit 700. Qualifying circuit 700 may be another example of qualifier 560, and may be suitable for practicing one or more example embodiments of the invention. The like-numbered elements of qualifying circuits 600 and 700 are identical in configuration and function. Circuit 700, however, includes OR gate 750; thus, as discussed in the following description, the circuit is configured to detect a frequency component in oversampled data over a greater number of oversampled bits, i.e., whereas circuit 600 can operate to detect a frequency component over 24 oversampled bits, circuit 700 can operate to detect a frequency component over 44 oversampled bits. Therefore, circuit 700 can perform the operations of general equations (9)-(12) in the specific circumstance where N=5 and W=4.

The operation of circuit 700 can be as follows. Elements 710, 720, 730, and 740 perform in a manner corresponding to like-numbered elements in circuit 600. As described above in connection with FIG. 6, the output of OR gate 740 represents a frequency component detection over a four-bit width, i.e., q[4] through q[0], as given by equation (1)-(5). In circuit 700, however, the output of gate 740 is not “Q.” Rather, another frequency-detecting component (not shown), which can be comprised of XOR, AND, and OR gates in a manner similar to that shown by FIGS. 6 and/or 7, can output frequency component detection over another portion of the oversampled data. Thus, the output of OR gate 740 corresponds to T[0], as given by equation (12), and the output of the other frequency-detecting component corresponds to T[1].

Those having skill in the art will recognize that the bit range needed to compute T[0] and T[1], as given by equation (12), is pdata[44:0]. Thus, pdata[44:40], which are not shown in FIG. 7, can be registered pdata[4:0], i.e., pdata[4:0] from a previous clock cycle, which can be stored in a data register for use in a later cycle. In this manner, pdata[44:0] can be accessible for the multiple frequency detecting components associated with FIG. 7.

The two outputs described above can be input into OR gate 750. The output of OR gate 750 is thus “Q.” as given by equation (11). “Q” is a qualifying signal which represents whether there is a frequency component detection over the entire range of oversampled data at input ports 710. The output “Q” from OR gate 750 can be used in a manner similar to that described above in connection with OR gate 640 (e.g., “Q” can be passed to a decision logic or to another circuit element or device).

FIG. 8 illustrates an example operation of a CDR circuit such as, for example, CDR circuit 500. FIG. 8 shows a time-domain illustration of four different signals: “pdata,” “burst reset,” “Q.” and “CDR locked.” The signal “pdata” corresponds to incoming data of an upstream data transmission (e.g., a T-CONT), which can be an input to a deserializer such as, for example, deserializer 510. The signal “pdata” can be oversampled, resulting in oversampled data (e.g., pdata[39:0], as described in connection with FIG. 6). The signal “burst reset” is a signal which can be passed to a decision logic in order to reset a CDR lock of the decision logic. A burst reset signal is described above in connection with FIG. 5. The signal “Q” is a qualifying signal, which can be passed from a qualifier (e.g., qualifier 560 and qualifying circuits 600 and 700) to a decision logic (e.g., a decision logic of sampling point decider 520). A qualifying signal is described above in connection with FIGS. 4-7. The signal “CDR locked” represents the internal state of a decision logic, i.e., whether or not the CDR performed by the decision logic is locked. “CDR locked” need not be a physical signal or waveform (although it is not precluded from being such); rather “CDR locked” simply can be a representation of the operating state of a decision logic.

In the following description of FIG. 8, and as illustrated in the subject figure, various signals are referred to as having or changing between “high” or “low” values. The use of these terms (and the description pertaining thereto) is simply as a placeholder for what may be a more complex operation of the various components of the CDR circuit; although “high” and “low” may correspond to binary values “1” and “0,” respectively, this need not be the case. Those having skill in the relevant arts will recognize that the signals represented in FIG. 8 are simply qualitative rather than quantitative representations, and, upon reading the following description, will understand how to operate a CDR circuit in ways other than the example operation shown and described.

A description of an example interrelation of the signals shown in FIG. 8 is as follows. Beginning at the earliest time shown (and progressing forward in time), an incoming burst transmission (“pdata”) is completed. During this time, the CDR is locked from a locking procedure completed during the prior operation of the circuit (e.g., during a previous burst transmission). Once the burst transmission is completed, the CDR remains locked, pending a reset signal (“burst reset”). When the burst reset signal is given, the CDR unlocks. During this time, there is no incoming burst transmission; unlocking occurs during a signal gap between incoming transmissions. Upon the beginning of a new burst transmission, a preamble (as part of “pdata”) is transmitted to the CDR circuit. During this time, the preamble is oversampled and processed by the qualifying circuit, which can perform pattern detecting on the preamble through the calculation of pattern detection equations (as described above in connection with FIGS. 4, 6, and 7). Upon a detection of a frequency component by the qualifying circuit, a non-zero “Q” signal is output. Such signal can be output to, for example, a decision logic, in turn qualifying the logic to lock onto the oversampled data. Once the CDR locks (as indicated by a high “CDR locked” signal), the qualifying circuit can cease computation of the pattern detection equations, and “Q” can go low. Because the CDR procedure of the decision logic has been qualified by the qualifying circuit, the CDR can quickly and accurately lock onto samples of the incoming data transmission (“pdata”) prior to the delimiter and encoded data portions of the transmission. Thus, the CDR procedure can recover data from the transmission at a lower BER.

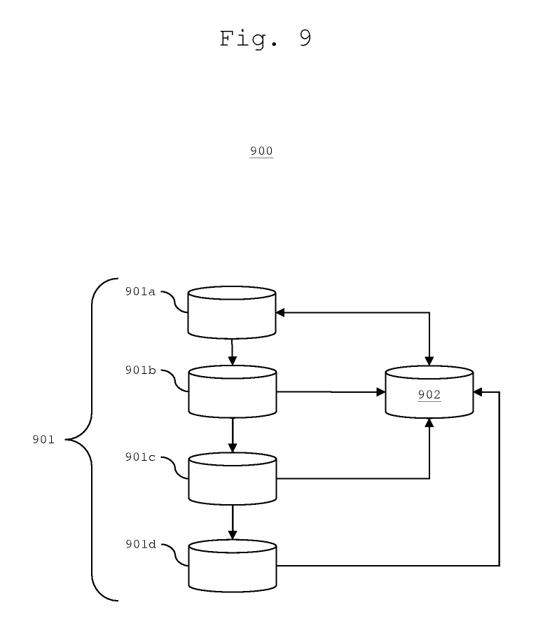

FIG. 9 illustrates a logical diagram 900 of modules such as, for example, application-specific integrated circuits (ASICs) or field-programmable gate arrays (FPGAs), which can be used in accordance with one or more example embodiments of the invention. The modules illustrated by diagram 900 can be used as or in association with the modules (e.g., deserializer 510, sampling point decider 520, demultiplexer 530, byte aligner 540, delay register 550, and qualifier 560), circuits (e.g., CDR circuit 500 and qualifying circuits 600 and 700), and/or circuit elements (e.g., oversampler 511, shift register 512, buffer 513, input ports 610 and 710, XOR gates 620 and 720, AND gates 630 and 730, and OR gates 640, 740, and 750) described herein.

Logical diagram 900 includes a CDR module 901 for performing CDR on digital data transmissions and a communication module 902 for directing information between sub-modules of CDR module 901, as well as receiving data (e.g., a upstream data transmitted in a PON, such as a T-CONT) from and sending data (e.g., recovered data, such as recovered bytes) to other modules, circuit devices, and/or network elements.

The CDR module 901 includes: a sub-module 901a that oversamples a digital transmission; a sub-module 901b arranged to detect a frequency component in an oversampled digital transmission; a sub-module 901c that can qualify a decision logic; and a sub-module 901d that selects samples of the oversampled digital transmission.

The communication module 902 can send digital transmissions to sub-module 901a for oversampling, and can receive oversampled data from sub-module 901a. The communication module 902 also can send oversampled data to sub-module 901b in order for sub-module 901b to detect a frequency component in the data, and also can receive frequency component detections from sub-module 901b. The communication module 902 further can send detections of frequency components to sub-module 901c for qualification of a decision logic, and further can receive qualifications from sub-module 901c. The communication module can send qualifications to sub-module 901d to qualify sub-module 901d, and also can send oversampled data to the submodule in order for it to select one or more samples from the oversampled data. Communication module 902 can received selections of oversampled data from the submodule 901d.

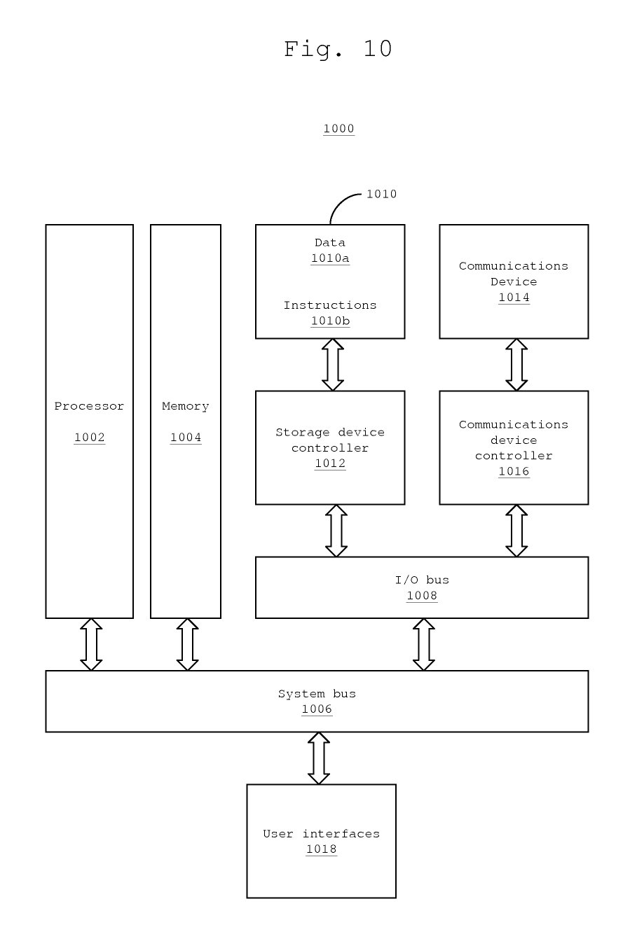

FIG. 10 is a diagram of an example data processing system which, according to various example embodiments, can form, be incorporated in, or be a part of, for example, any network element shown in FIG. 1 (e.g., an OLT and/or ONT). Data processing system 1000 includes a processor 1002 coupled to a memory 1004 via a system bus 1006. Processor 1002 may be comprised of or contain one or more components of a CDR circuit such as, for example, CDR circuit 500 or qualifying circuits 600 and 700 (all of which are not shown in FIG. 10) or, in other embodiments of the invention, the functionality of any or all of these circuits may be effected using a computer program having program instructions 1010b stored in a storage device 1010. The processor 1002 is also coupled to external devices (not shown) via the system bus 1006 and an input/output (I/O) bus 1008, and at least one user interface 1018. The processor 1002 may be further coupled to a communications device 1014 via a communications device controller 1016 coupled to the I/O bus 1008. The processor 1002 uses the communications device 1014 to communicate with a network such as, for example, a PON, and the communications device 1014 may have one or more I/O ports. Processor 1002 also can include an internal clock (not shown in FIG. 10) to keep track of time and periodic time intervals. The user interface 1018 may include, for example, at least one of a keyboard, mouse, trackball, touch screen, keypad, or any other suitable user-operable input device, and at least one of a video display, speaker, printer, or any other suitable output device enabling a user to receive outputted information.

A storage device 1010 having a computer-readable medium is coupled to the processor 1002 via a storage device controller 1012, the I/O bus 1008 and the system bus 1006. The storage device 1010 is used by the processor 1002 and storage device controller 1012 to read and write data 1010a, and to store program instructions 1010b. Alternately, program instructions 1010b can be stored directly in non-volatile or volatile portions of memory 1004. Program instructions 1010b can be used to implement, for example, procedures described in connection with FIGS. 4-8.

The storage device 1010 can also store various routines and operating systems, such as Microsoft Windows, UNIX, and LINUX, or the like, that can be used by the processor 1002 for controlling the operation of system 1000. At least one of the operating systems stored in storage device 1010 can include the TCP/IP protocol stack for implementing a known procedure for connecting to the Internet or another network, and can also include web browser software for enabling a user of the system 1000 to navigate or otherwise exchange information with the World Wide Web.

In operation, the processor 1002 loads the program instructions 1010b from the storage device 1010 into the memory 1004. The processor 1002 then executes the loaded program instructions 1010b to perform at least part of the example procedures described herein.

By virtue of the example embodiments described herein, a decision logic can be qualified to perform a CDR procedure on digital communications such as upstream data transmissions in FTTx networks. By qualifying the decision logic, a CDR procedure can be operated at a lower BER, thus allowing communications streams to be transmitted at higher data bit rates.

In the foregoing description, example aspects of the present invention are described with reference to specific example embodiments. Despite these specific embodiments, many additional modifications and variations would be apparent to those skilled in the art. Thus, it is to be understood that example embodiments of the invention may be practiced in a manner otherwise than as specifically described. For example, although one or more example embodiments of the invention may have been described in the context of an oversampling ratio N equal to five, it should be understood that the invention is not so limited, and that in practice the example embodiments may include or incorporate any other type of content. Accordingly, the specification is to be regarded in an illustrative rather than restrictive fashion. It will be evident that modifications and changes may be made thereto without departing from the broader spirit and scope.

Similarly, it should be understood that the figures are presented solely for example purposes. The architecture of the example embodiments presented herein is sufficiently flexible and configurable such that it may be practiced (and navigated) in ways other than that shown in the accompanying figures.

Software embodiments of the example embodiments presented herein may be provided as a computer program product, or software, that may include an article of manufacture on a machine-accessible, machine-readable, or computer-readable medium having instructions. The instructions on the machine-accessible, machine-readable, or computer-readable medium may be used to program a computer system or other electronic device. The machine-readable or computer-readable medium may include, but is not limited to, floppy diskettes, optical disks, CD-ROMs, and magneto-optical disks or other type of media suitable for storing or transmitting electronic instructions. The techniques described herein are not limited to any particular software configuration. They may find applicability in any computing or processing environment. As used herein, the terms “machine-accessible medium,” “machine-readable medium,” or “computer readable medium” shall include any medium capable of storing, encoding, or transmitting an instruction or sequence of instructions for execution by the machine such that the machine performs any one or more of the procedures described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result.

Furthermore, the purpose of the foregoing abstract is to enable the U.S. Patent and Trademark Office, the general public, and scientists, engineers, and practitioners in the art who are unfamiliar with patent or legal terms or phrases, to quickly determine from a cursory inspection the nature and essence of the technical disclosure of the application. The abstract is not intended to limit the scope of the present invention in any way. It is also to be understood that the processes recited in the claims need not be performed in the order presented.

What is claimed is:

1. A method for performing clock phase and data recovery on a digital transmission, the method comprising:
oversampling the digital transmission into oversampled data;
detecting a frequency component of the oversampled data;
qualifying a decision logic to select a sample of the oversampled data; and
selecting at least one sample of the oversampled data using the decision logic.

2. The method of claim 1, wherein the digital transmission is comprised of a preamble, a delimiter, and encoded data.

3. The method of claim 2, wherein the oversampled data is the preamble.

4. The method of claim 3, wherein the decision logic is qualified based upon Q, where Q is given by the equation
$$Q = {{⋃}_{i = 0}}^{N - 1} q [ i ] ,$$
where N is an oversampling ratio of the oversampled data, i is a first index variable, and q[i] is given by the logical equation
$$q [ i ] = {{⋂}_{j = 0}}^{W - 1} ( pdata [ i + j \cdot N ] ⊕ pdata [ i + ( j + 1 ) \cdot N ] ) ,$$
where W is a qualifying width, j is a second index variable, and pdata corresponds to the oversampled data.

5. The method of claim 3, wherein the decision logic is qualified based upon Q, where Q is given by the equation
$$Q = {{⋃}_{i = 0}}^{N - 1} {q}^{′} [ i ] ,$$
where N is an oversampling ratio of the oversampled data, i is a first index variable, and q′[i] is given by the logical equation
$${q}^{′} [ i ] = {{⋃}_{k = 0}}^{M} \{ {{⋂}_{j = k \cdot W}}^{( k + 1 ) \cdot W - 1} ( pdata [ i + j \cdot N ] ⊕ pdata [ i + ( j + 1 ) \cdot N ] ) \} ,$$
where W is a qualifying width, k is a second index variable, j is a third index variable, M is a largest integer less than 8/W, and pdata corresponds to the oversampled data.

6. The method of claim 3, wherein the decision logic is qualified based upon Q, where Q is given by the equation
$$Q = {{⋃}_{k = 0}}^{M} T [ k ]$$
where k is a first index variable, W is a qualifying width, M is a largest integer less than 8/W, and T[k] is given by the logical equation
$$T [ k ] = {{⋃}_{i = 0}}^{N - 1} \{ {{⋂}_{j = k \cdot W}}^{( k + 1 ) \cdot W - 1} ( pdata [ i + j \cdot N ] ⊕ pdata [ i + ( j + 1 ) \cdot N ] ) \} ,$$
where N is an oversampling ratio of the oversampled data, i is a second index variable, j is a third index variable, and pdata corresponds to the oversampled data.

7. The method of claim 1, wherein the digital transmission is an upstream communication in a PON.

8. The method of claim 7 wherein the upstream communication travels from an ONT to an OLT.

9. A communications system for performing clock phase and data recovery on a digital transmission, the communications system comprising:
at least two communicatively coupled network elements,
wherein at least one of the at least two network elements is arranged to oversample the digital transmission into oversampled data, detect a frequency component of the oversampled data, qualify a decision logic to select a sample of the oversampled data, and select at least one sample of the oversampled data using the decision logic.

10. The communications system of claim 9, wherein the digital transmission is comprised of a preamble, a delimiter, and encoded data.

11. The communications system of claim 10, wherein the oversampled data is the preamble.

12. The communications system of claim 11, wherein the decision logic is qualified based upon Q, where Q is given by the equation
$$Q = {{⋃}_{i = 0}}^{N - 1} q [ i ] ,$$
where N is an oversampling ratio of the oversampled data, i is a first index variable, and q[i] is given by the logical equation
$$q [ i ] = {{⋂}_{j = 0}}^{W - 1} ( pdata [ i + j \cdot N ] ⊕ pdata [ i + ( j + 1 ) \cdot N ] ) ,$$
where W is a qualifying width, j is a second index variable, and pdata corresponds to the oversampled data.

13. The communications system of claim 11, wherein the decision logic is qualified based upon Q, where Q is given by the equation
$$Q = {{⋃}_{i = 0}}^{N - 1} {q}^{′} [ i ] ,$$
where N is an oversampling ratio of the oversampled data, i is a first index variable, and q′ [i] is given by the logical equation
$${q}^{′} [ i ] = {{⋃}_{k = 0}}^{M} \{ {{⋂}_{j = k \cdot W}}^{( k + 1 ) \cdot W - 1} ( pdata [ i + j \cdot N ] ⊕ pdata [ i + ( j + 1 ) \cdot N ] ) \} ,$$
where W is a qualifying width, k is a second index variable, j is a third index variable, M is a largest integer less than 8/W, and pdata corresponds to the oversampled data.

14. The communications system of claim 11, wherein the decision logic is qualified based upon Q, where Q is given by the equation
$$Q = {{⋃}_{k = 0}}^{M} T [ k ]$$
where k is a first index variable, W is a qualifying width, M is a largest integer less than 8/W, and T[k] is given by the logical equation
$$T [ k ] = {{⋃}_{i = 0}}^{N - 1} \{ {{⋂}_{j = k \cdot W}}^{( k + 1 ) \cdot W - 1} ( pdata [ i + j \cdot N ] ⊕ pdata [ i + ( j + 1 ) \cdot N ] ) \} ,$$
where N is an oversampling ratio of the oversampled data, i is a second index variable, j is a third index variable, and pdata corresponds to the oversampled data.

15. The communications system of claim 9, wherein the digital transmission is an upstream communication in a PON.

16. The communications system of claim 15, wherein the upstream communication travels from an ONT to an OLT.

17. A network element operating in a communications network, the network element comprising:
a communications interface coupled to a network providing a plurality of communication services;
a storage device arranged to store program instructions; and
a processor coupled to the communications interface and the storage device, and operating under the control of the program instructions to communicate a digital transmission with the network through the communications interface,
wherein the processor operates under control of the program instructions to perform oversampling of the digital transmission into oversampled data, detecting of a frequency component of the oversampled data, qualifying of a decision logic to select a sample of the oversampled data, and selecting of at least one sample of the oversampled data using the decision logic.

18. The network element of claim 17, wherein the digital transmission is comprised of a preamble, a delimiter, and encoded data.

19. The network element of claim 18, wherein the oversampled data is the preamble.

20. The network element of claim 19, wherein the decision logic is qualified based upon Q, where Q is given by the equation
$$Q = {{⋃}_{i = 0}}^{N - 1} q [ i ] ,$$
where N is an oversampling ratio of the oversampled data, i is a first index variable, and q[i] is given by the logical equation
$$q [ i ] = {{⋂}_{j = 0}}^{W - 1} ( pdata [ i + j \cdot N ] ⊕ pdata [ i + ( j + 1 ) \cdot N ] ) ,$$
where W is a qualifying width, j is a second index variable, and pdata corresponds to the oversampled data.

21. The network element of claim 19, wherein the decision logic is qualified based upon Q, where Q is given by the equation
$$Q = {{⋃}_{i = 0}}^{N - 1} {q}^{′} [ i ] .$$
where N is an oversampling ratio of the oversampled data, i is a first index variable, and q′[i] is given by the logical equation
$${q}^{′} [ i ] = {{⋃}_{k = 0}}^{M} \{ {{⋂}_{j = k \cdot W}}^{( k + 1 ) \cdot W - 1} ( pdata [ i + j \cdot N ] ⊕ pdata [ i + ( j + 1 ) \cdot N ] ) \} ,$$
where W is a qualifying width, k is a second index variable, j is a third index variable, M is a largest integer less than 8/W, and pdata corresponds to the oversampled data.

22. The network element of claim 17, wherein the decision logic is qualified based upon Q, where Q is given by the equation
$$Q = {{⋃}_{k = 0}}^{M} T [ k ]$$
where k is a first index variable, W is a qualifying width, M is a largest integer less than 8/W, and T[k] is given by the logical equation
$$T [ k ] = {{⋃}_{i = 0}}^{N - 1} \{ {{⋂}_{j = k \cdot W}}^{( k + 1 ) \cdot W - 1} ( pdata [ i + j \cdot N ] ⊕ pdata [ i + ( j + 1 ) \cdot N ] ) \} ,$$
where N is an oversampling ratio of the oversampled data, i is a second index variable, j is a third index variable, and pdata corresponds to the oversampled data.

23. The network element of claim 22, wherein the network element is an OLT.

24. A computer program embodied in a computer-readable storage medium, the program having instructions which, when executed by a computer, cause the computer to perform a method for performing clock phase and data recovery on digital transmission, the method comprising:
oversampling the digital transmission into oversampled data;
detecting a frequency component of the oversampled data;
qualifying a decision logic to select a sample of the oversampled data; and
selecting at least one sample of the oversampled data using the decision logic.

25. An apparatus for performing clock phase and data recovery on digital transmission, the apparatus comprising:
an oversampler, arranged to oversample the digital transmission into oversampled data;
a frequency detector, arranged to detect a frequency component of the oversampled data;
a qualifier, arranged to qualify a decision logic to select a sample of the oversampled data; and
a sample selector, arranged to select at least one sample of the oversampled data using the decision logic.

26. The apparatus of claim 25, wherein the qualifier qualifies the decision logic based upon Q, where Q is given by the equation
$$Q = {{⋃}_{i = 0}}^{N - 1} q [ i ] ,$$
where N is an oversampling ratio of the oversampled data, i is a first index variable, and q[i] is given by the logical equation
$$q [ i ] = {{⋂}_{j = 0}}^{W - 1} ( pdata [ i + j \cdot N ] ⊕ pdata [ i + ( j + 1 ) \cdot N ] ) ,$$
where W is a qualifying width, j is a second index variable, and pdata corresponds to the oversampled data.

27. The apparatus of claim 25, wherein the qualifier qualifies the decision logic based upon Q, where Q is given by the equation
$$Q = {{⋃}_{i = 0}}^{N - 1} {q}^{′} [ i ] .$$
where N is an oversampling ratio of the oversampled data, i is a first index variable, and q′[i] is given by the logical equation
$${q}^{′} [ i ] = {{⋃}_{k = 0}}^{M} \{ {{⋂}_{j = k \cdot W}}^{( k + 1 ) \cdot W - 1} ( pdata [ i + j \cdot N ] ⊕ pdata [ i + ( j + 1 ) \cdot N ] ) \} ,$$
where W is a qualifying width, k is a second index variable, j is a third index variable, M is a largest integer less than 8/W, and pdata corresponds to the oversampled data.

28. The apparatus of claim 25, wherein the qualifier qualifies the decision logic based upon Q, where Q is given by the equation
$$Q = {{⋃}_{k = 0}}^{M} T [ k ]$$
where k is a first index variable, W is a qualifying width, M is a largest integer less than 8/W, and T[k] is given by the logical equation
$$T [ k ] = {{⋃}_{i = 0}}^{N - 1} \{ {{⋂}_{j = k \cdot W}}^{( k + 1 ) \cdot W - 1} ( pdata [ i + j \cdot N ] ⊕ pdata [ i + ( j + 1 ) \cdot N ] ) \} ,$$
where N is an oversampling ratio of the oversampled data, i is a second index variable, j is a third index variable, and pdata corresponds to the oversampled data.

29. A method for performing clock phase and data recovery on a digital transmission, the method comprising:
oversampling the digital transmission into oversampled data;
detecting periodicity in a preamble of the oversampled data;
enabling a decision logic to select samples of the oversampled data; and
selecting samples of the oversampled data using the decision logic.
